(19) United States
(12) Patent Application Publication
(10) Pub. No.: US 2013/0108454 A1
(43) Pub. Date: May 2, 2013

(54) ROTOR BLADE

(71) Applicant: SIEMENS AKTIENGESELLSCHAFT, Muenchen (DE)

(72) Inventor: SOEREN OEMANN LIND, Naestved (DK)

(73) Assignee: SIEMENS AKTIENGESELLSCHAFT, Muenchen (DE)

(21) Appl. No.: 13/633,294

(22) Filed: Oct. 2, 2012

(30) Foreign Application Priority Data
Oct. 27, 2011 (EP) 11186896.4

(51) Int. Cl. F03D 1/06

(52) U.S. Cl. CPC F03D 1/0675
USPC 416/229 R

(57) ABSTRACT

A rotor blade for a wind turbine includes a longitudinal rotor blade base body. A stiffening structure is disposed within the base body. The stiffening structure is divided in at least two, axially adjacently disposed stiffening structure segments, wherein at least one first stiffening structure segment is disposed with a different position or orientation relative to at least one further stiffening structure segment or relative to the longitudinal axis of the base body.

### CROSS REFERENCE TO RELATED APPLICATIONS

This application claims priority of European Patent Office application No. 11186896.4 EP filed Oct. 27, 2011. All of the applications are incorporated by reference herein in their entirety.

### FIELD OF INVENTION

The illustrated embodiments relate to a rotor blade for a wind turbine, comprising a longitudinal rotor blade base body, whereby a stiffening structure is disposed within the base body.

### BACKGROUND OF INVENTION

Diverse rotor blade constructions for wind turbines are known and usually comprise an appropriate stiffening structure within the rotor blade base body in order to withstand the high mechanical loads occurring during operation. As a rule, the mechanical load in a rotor blade is influenced by factors such as wind speed, rotor speed, and rotor blade pitch angle, which indicates the angle of attack of wind, etc. Generally, the higher the load the more material is used for building respective rotor blades, which usually leads to rotor blade constructions of high weight. Hence, in order to reduce the weight of respective rotor blade constructions it is a goal to reduce the loads encountered by the respective rotor blades in operation.

Therefore, different approaches are known from prior art which are based on the principle of building a rotor blade construction which is able to create an inherent twist or torque due to occurring loads. By the twist or rotation around its longitudinal axis, the rotor blade is able to reduce the rotor blade area being exposed to the wind giving rise to a reduced load situation. The creation of an inherent twist may be achieved in a certain arrangement and/or orientation of fibres building respective rotor blades relative to an axis of the rotor blade such as proposed in U.S. Pat. No. 7,802,968.

However, the known approaches for respective rotor blade constructions having the ability of creating an inherent twist or torque under external loads are oftentimes comparatively cumbersome and costly.

### SUMMARY OF INVENTION

It is desirable to provide an improved rotor blade having the ability of creating an inherent twist or torque under application of external loads.

This is achieved by a rotor blade as initially described, wherein the stiffening structure is divided in at least two axially adjacently disposed stiffening structure segments, whereby at least one first stiffening structure segment is disposed with a different position and/or orientation relative to at least one further stiffening structure segment and/or relative to the longitudinal axis of the base body.

The above principle provides a rotor blade construction, whereby the internal stiffening structure usually extending from the blade root to the blade tip is axially segmented in respective axially adjacently disposed stiffening structure segments. The ability of creating an inherent twist or torque allowing the rotor blade to rotate around the longitudinal axis of the base body under external load is provided by disposing at least one first stiffening structure segment with a different position and/or orientation relative to at least one further stiffening structure segment. Additionally or alternatively, the respective inherent twist or torque may be realised by disposing at least one respective first stiffening structure segment with a different position and/or orientation relative to the longitudinal axis of the base body.

Regarding the case of different orientations of respective first stiffening structure segments relative to respective further stiffening structure segments and/or the longitudinal axis of the base body, it is possible that the orientation of respective first stiffening structure segments is only partially different relative to respective further stiffening structure segments and/or the longitudinal axis of the base body. I.e., a respective first section of a respective first stiffening structure segment shares the same orientation as a respective further stiffening structure segment and/or the longitudinal axis of the base body, whereas a second section of the respective first stiffening structure segment has a different orientation relative to the respective further stiffening structure segment and/or the longitudinal axis of the base body. Hence, an exemplary first stiffening structure segment may comprise a first section extending in the direction of the longitudinal axis of the base body and a second section extending with a certain angle relative to the longitudinal axis of the base body. Of course, a respective first stiffening structure segment may also comprise more than one respective first and second section.

Since the position and/or orientation of respective first stiffening structure segments deviates from further stiffening structure segments or the extension of the longitudinal axis of the base body, local modifications and/or differences in the mechanical behaviour of the base body may be realised along the longitudinal axis of the base body which leads to the desired generation of inherent twist or torque under load. As mentioned above, by twisting the rotor blade, the angle of attack may be reduced leading to a reduction of the loading of the rotor blade.

The concrete arrangement of respective first stiffening structure segments and further stiffening structure segments mainly defines the mechanical behaviour of the rotor blade, so that in dependence of the axial arrangement and number of respective first stiffening structure segments an individual and concerted adjustment of the mechanical properties of respective rotor blades is feasible.

The number of respective stiffening structure segments is at least two. The number of the stiffening structure segment will be mainly defined by the axial dimensions, ie the length of the base body of the rotor blade. Generally, an arbitrary number of respective stiffening structure segment is possible.

As a rule, the twisted or tilted arrangement of first stiffening structure segments is capable of creating the mentioned twist or torque around the longitudinal axis of the base body of the rotor blade when the rotor blade is exposed to external forces.

The longitudinal axis is defined as the line extending between the root and the tip of the base body independent of the concrete geometrical shape of the base body. Hence, the longitudinal axis may be a straight line for base bodies having a straight, linear design or an at least partially curved line for base bodies having an at least partially curved design.

According to an exemplary embodiment, the at least one first stiffening structure segment may be tilted or twisted relative to the longitudinal axis of the base body. Thus, respective first stiffening structure segments are concertedly inclined, i.e. disposed with a certain angle relative to the longitudinal axis of the base body. Thereby, the geometrical axis of a first stiffening structure segment does not coincide with the longitudinal axis of the base body.

If two or more first stiffening structure segments are tilted or twisted relative to the longitudinal axis of the base body, the tilting or twisting angles of the respective stiffening structure segments may be equal or different.

According to another exemplary embodiment, the at least one stiffening structure segment is coaxially disposed within the longitudinal axis of the base body, whereby it is tilted or twisted relative to the at least one further stiffening structure segment. Thus, respective first stiffening structure segments coaxially extend with the longitudinal axis of the base body, i.e. the geometrical axis, for example, the longitudinal axis, of a respective first stiffening structure segment coincides with the longitudinal axis of the base body.

If two or more stiffening structure segments are coaxially disposed within the longitudinal axis of the base body, whereby they are tilted or twisted relative to the at least one further stiffening structure segment, the tilting or twisting angles of the respective stiffening structure segments may be equal or different.

According to a further exemplary embodiment, the at least one stiffening structure segment is internally tilted or twisted relative to its own longitudinal axis. Thus, a respective first stiffening structure segment comprises at least two geometrical planes. A respective first stiffening structure segment may have a three-dimensionally curved, inclined, or tilted geometry.

If two or more stiffening structure segments are internally tilted or twisted relative to their own longitudinal axis, the tilting or twisting angles of the respective stiffening structure segments may be equal or different.

Regarding the arrangement of respective stiffening structure segments within the base body of the rotor blade, it is possible that a first stiffening structure segment disposed at an axially inner position of the base body is disposed tilted or twisted and at least one further stiffening structure segment disposed at an axially outer position of the base body is disposed un-tilted, or vice versa. Of course, arbitrary arrangements of respective first stiffening structure segments relative to respective further stiffening structure segments are generally possible. It is thinkable that groups of axially adjacently disposed first stiffening structure segments alternate with groups of axially adjacently disposed further stiffening structure segments.

Regarding respective tilting or twisting angles of respective first stiffening structure segments, it is possible that a first stiffening structure segment is tilted or twisted with an angle of ca. 5-30°, particularly 15-20°, relative to the at least one further stiffening structure segment or the longitudinal axis of the base body in clockwise direction or anti-clockwise direction. Of course, other tilting or twisting angles are feasible in exceptional cases regarding a longitudinal, horizontal, or vertical axis of the base body.

In a further embodiment, axially adjacently disposed stiffening structure segments may at least partially overlap each other in axial direction. The degree of overlap is crucial for the mechanical properties of the respective portion of the base body of the rotor blade. Generally, large overlap areas lead to great mechanical strength. Hence, the degree of overlap is a measure to locally adjust the mechanical properties of the rotor blade and further the ability of creating an inherent twist or torque.

Respective stiffening structure segments within the base body may have the same or different dimensions, particularly in longitudinal direction of the base body. Hence, the illustrated stiffening structure segments essentially have the same or different lengths. The geometrical dimensions of respective stiffening structure segments are also a measure in order to locally adjust the mechanical properties of the base body.

A stiffening structure segment may comprise a stiffening web structure built of at least one fibre based, particularly carbon fibre based, fabric within a matrix material. Hence, in one embodiment, a respective stiffening structure segment may be a composite component having concertedly directed and orientated fibres or fabrics within a, particularly resin-like, matrix material. The fibres may be carbon fibres due to their outstanding mechanical properties. Yet, other fibre materials such as glass-fibre or organic fibres are feasible as well. A respective stiffening structure segment may be built of other materials than the aforementioned such as metal in exceptional cases.

A further aspect relates to a wind turbine, particularly a direct drive wind turbine, comprising a rotor hub having at least one rotor blade attached thereto. The at least one rotor blade is one of the type as described before. The at least one rotor blade is rotatably supported relative to the rotor hub. “Rotatably supported” means that the rotor blade may twist or rotate relative to its own longitudinal axis by the creation of an inherent twist or torque and is not to be confused with respective devices for changing the pitch angle of the rotor blade.

### BRIEF DESCRIPTION OF THE DRAWINGS

Illustrated embodiments are described in detail as reference is made to the principle figures, whereby:

FIG. 1 shows a wind turbine;

FIG. 2 shows a perspective view of an exemplary embodiment of a rotor blade in an unloaded and loaded state;

FIG. 3 shows cross-sectionally cut views of the rotor blade of FIG. 2; and

FIG. 4-10 show principle views of exemplary embodiments of rotor blades.

### DETAILED DESCRIPTION OF INVENTION

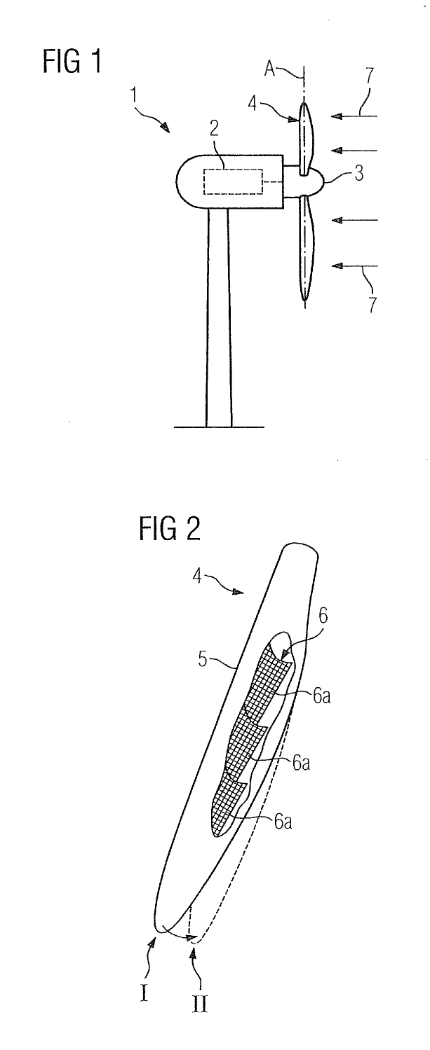

FIG. 1 shows a principle view of a wind turbine 1. The wind turbine 1 may be applicable for offshore applications. The wind turbine 1 is a direct drive wind turbine, i.e.

the generator 2 of the wind turbine 1 is directly connected to the rotor hub 3. A number of rotor blades 4 are attached to the rotor hub 3.

The rotor blades 4 are rotatably supported relative to the rotor hub 3, i.e. may rotate around their longitudinal axis A by an inherently created twist or torque under load particularly in times of high wind speed (cf. arrows 7 indicating the externally applied wind forces).

A rotor blade 4 comprises a longitudinal base body 5. The base body 5 is a composite component, i.e. the base body 5 includes fabrics of a multi-layered technical fibre material disposed within a resin-like matrix such as polyurethane for instance. The base body 5 may be at least partially hollow. A stiffening structure 6 is disposed within the base body 5. The stiffening structure 6 serves to provide the base body 5 with additional stiffness or generally mechanical stability.

The stiffening structure 6 is segmented in respective stiffening structure segments 6a, 6b (cf. FIG. 2 for instance). Each stiffening structure segment 6a, 6b is also a composite component comprising a stiffening web structure built of a fibre based, particularly carbon fibre based, fabric within a matrix material such as polyurethane for instance.

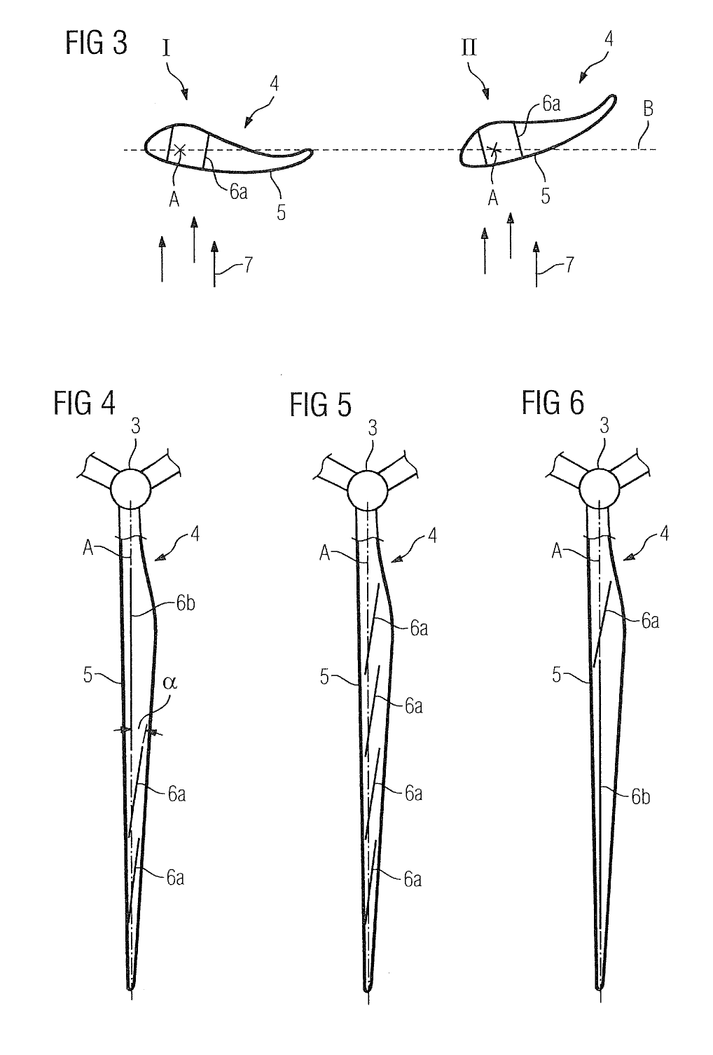

FIG. 2 shows a perspective view of a rotor blade 4 in an unloaded state I and an loaded state II, respectively. FIG. 3 shows respective cross-sectionally cut views of the rotor blade 4 of FIG. 2.

As is discernible from FIG. 2, the stiffening structure 6 is axially segmented in a number of axially adjacently disposed stiffening structure segments 6a, 6b. Thereby, first stiffening structure segments 6a are disposed with a different position and/or orientation relative to further stiffening structure segments 6b and/or relative to the longitudinal axis A of the base body 5.

The embodiment of FIG. 2 shows respective first stiffening structure segments 6a which are tilted relative to the longitudinal axis A of the base body 5. The tilting angle a (cf. FIG. 4) of the respective first stiffening structure segments 6a relative to the longitudinal axis A of the base body 5 may be ca. 15-20° for instance.

The different position and/or orientation of the first stiffening structure segments 6a relative to the longitudinal axis A of the base body 5 leads to an axially locally different mechanical behaviour of the base body 5 so that the rotor blade 4 will rotate around its longitudinal axis corresponding to the longitudinal axis A of the base body 5 under the application of external load. The degree of rotation of the rotor blade 4 is dependent on the externally applied forces. In such a manner, the angle of attack or the respective area the rotor blade 4 is exposed to the wind is changed resulting in a reduction of the load on the rotor blade 4. The rotation of the rotor blade 4 is to be seen in FIG. 2 when comparing the positions and/or orientations of the axially outer portions of the rotor blade 4.

It is discernible from FIG. 3 showing cross-sectional cut views of the rotor blade 4 of FIG. 2, that the rotor blade 4 has an optimised position relative to the externally applied forces (cf. arrows 7) in the loaded state II (right) in comparison to the unloaded state I (left) due to a rotation around the longitudinal axis A of the base body 5. The rotation is best to be seen when comparing the respective positions and/or orientations of the blade root of the rotor blade 4 in FIG. 3 (note auxiliary axis B).

FIG. 4-10 show diverse further exemplary embodiments of rotor blades 4. The respective embodiments of rotor blades 4 essentially differ in the arrangement, position and/or orientation of respective first stiffening structure segments 6a and/or further stiffening structure segments 6b. Generally, arbitrary arrangements of first stiffening structure segments and further stiffening structure segments 6b are possible. Usually, the base body 5 of the rotor blade 4 is provided with respective stiffening structure segments 6a, 6b axially extending from the blade root to the blade tip.

The embodiment of FIG. 4 shows an arrangement of one further stiffening structure segment 6b having an axially inner position and two respective first stiffening structure segments 6a having axially outer positions. The first stiffening structure segments 6a are tilted relative to the longitudinal axis A of the base body 5. The tilting angles α of the two first stiffening structure segments 6a relative to the longitudinal axis A of the base body 5 are different. Overlapping portions are provided between axially adjacently disposed first stiffening structure segments 6a as well as axially adjacently disposed first stiffening structure segments 6a and further stiffening structure segments 6b. The degree of overlap indicates the mechanical stability of the rotor blade 4 in the respective portion of the base body 5.

The embodiment of FIG. 5 shows a rotor blade 4 having four essentially parallel aligned first stiffening structure segments 6a. Hence, the respective stiffening structure segments 6a have the same tilting angle a relative to the longitudinal axis A of the base body 5. Again, a certain degree of axial overlap is provided between axially adjacently disposed first stiffening structure segments 6a.

FIG. 6 shows an embodiment of a rotor blade 4 having the stiffening structure 6 segmented in only two respective stiffening structure segments 6a, 6b. Thereby, a first stiffening structure segment 6a has an axially inner position in comparison to the further stiffening structure segment 6b. It is discernible from FIG. 6 that respective stiffening structure segments do not necessarily comprise the same dimensions.

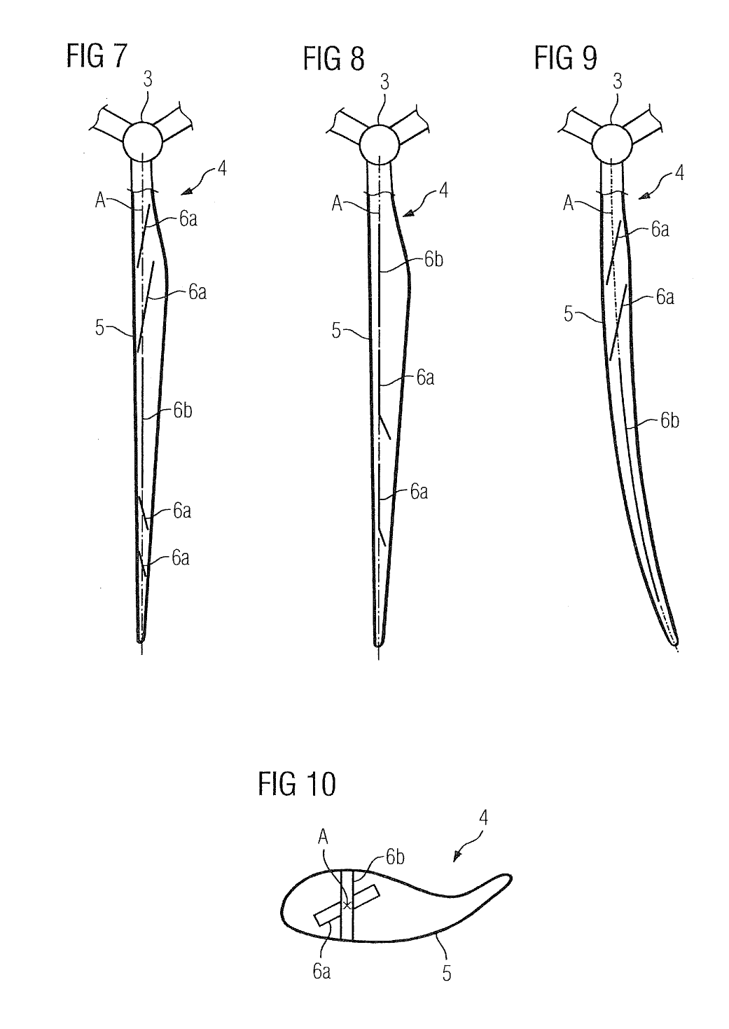

The embodiment of FIG. 7 shows an arrangement of five stiffening structure segments 6a, 6b. Thereby, the two first stiffening structure segment 6a having an axially inner position having an opposite orientation in comparison to the two first stiffening structure segments 6a having an axially outer position. Hence, two groups of first stiffening structure segments 6a are built differing in their orientation. A further stiffening structure segment 6b is disposed in between the respective groups of first stiffening structure segments 6a.

FIG. 8 shows an embodiment of respective first stiffening structure segments 6a having a partially different orientation than respective further stiffening structure segments 6b. Thereby, the respective first stiffening structure segments 6a comprise a first portion extending in the direction of the longitudinal axis A of the base body 5 and a second portion extending with an angle relative to the longitudinal axis A of the base body 5. It is possible that a respective partial change of the orientation of respective first stiffening structure segments 6a in comparison to the longitudinal axis A of the base body 5 may also lead to the desired effect of creating an inherent twist or torque of the rotor blade 4 under load.

The embodiment of FIG. 9 shows that a rotor blade 4 must not necessarily have a straight shape. The rotor blade 4 of FIG. 9 has a partially curved shape. The arrangement of respective stiffening structure segments 6a, 6b is of course also possible with respective curved designs of rotor blades 4. The longitudinal axis A is defined as the line extending from the blade root to the blade tip.

The embodiment of FIG. 10 shows that a first stiffening structure segment 6a may be coaxially disposed within the longitudinal axis A of the base body 5. Yet, it is tilted or twisted relative to the at least one further stiffening structure segments 6b.

While specific embodiments have been described in detail, those with ordinary skill in the art will appreciate that various modifications and alternative to those details could be developed in light of the overall teachings of the disclosure. For example, elements described in association with different embodiments may be combined. Accordingly, the particular arrangements disclosed are meant to be illustrative only and should not be construed as limiting the scope of the claims or disclosure, which are to be given the full breadth of the appended claims, and any and all equivalents thereof. It should be noted that the term “comprising” does not exclude other elements or steps and the use of articles “a” or “an” does not exclude a plurality.

1. A rotor blade for a wind turbine, comprising:
a longitudinal rotor blade base body,
a stiffening structure disposed within the base body,
wherein the stiffening structure is divided in at least two, axially adjacently disposed stiffening structure segments, and
wherein at least one first stiffening structure segment is disposed with a different position or orientation relative to at least one further stiffening structure segment or relative to the longitudinal axis of the base body.

2. The rotor blade according to claim 1, wherein the at least one first stiffening structure segment is tilted or twisted relative to the longitudinal axis of the base body.

3. The rotor blade according to claim 1, wherein the at least one first stiffening structure segment is coaxially disposed within the longitudinal axis of the base body, wherein it is tilted or twisted relative to the at least one further stiffening structure segment.

4. The rotor blade according to claim 1, wherein the at least one first stiffening structure segment is internally tilted or twisted relative to its own longitudinal axis.

5. The rotor blade according to claim 2, wherein, if two or more first stiffening structure segments are tilted or twisted relative to the longitudinal axis of the base body, the tilting or twisting angles of the respective stiffening structure segments are equal or different.

6. The rotor blade according to claim 3, wherein, if two or more stiffening structure segments are coaxially disposed within the longitudinal axis of the base body, wherein they are tilted or twisted relative to the at least one further stiffening structure segment, the tilting or twisting angles of the first respective stiffening structure segments are equal or different.

7. The rotor blade according to claim 4, wherein, if two or more first stiffening structure segments are internally tilted or twisted relative to their own longitudinal axis, the tilting or twisting angles of the respective first stiffening structure segments are equal or different.

8. The rotor blade according to claim 2, wherein a first stiffening structure segment disposed at an axially inner position of the base body is disposed tilted or twisted and at least one further stiffening structure segment disposed at an axially outer position of the base body is disposed un-tilted, or vice versa.

9. The rotor blade according to claim 2, wherein a first stiffening structure segment is tilted or twisted with an angle of 5-30°, particularly, 15-20°, relative to the at least one further stiffening structure segment or the longitudinal axis of the base body in clockwise direction or anti-clockwise direction.

10. The rotor blade according to claim 1, wherein axially adjacently disposed stiffening structure segments at least partially overlap each other in axial direction.

11. The rotor blade according to claim 1, wherein the stiffening structure segments are of the same or different dimensions, particularly in longitudinal direction of the base body.

12. The rotor blade according to claim 1, wherein a stiffening structure segment comprises a stiffening web structure built of at least one fibre based fabric within a matrix material.

13. The rotor blade according to claim 12, wherein the fibre based fabric is a carbon fibre based fabric.

14. A wind turbine, comprising:
a rotor hub having at least one rotor blade according to claim 1 attached thereto, wherein the at least one rotor blade is rotatably supported relative to the rotor hub.

15. The wind turbine as claimed in claim 14, wherein the wind turbine is a direct drive wind turbine.
